(19) United States
(12) Patent Application Publication
(10) Pub. No.: US 2022/0116656 A1
(43) Pub. Date: Apr. 14, 2022

(54) IMPROVED INTRA PLANAR PREDICTION USING MERGE MODE MOTION VECTOR CANDIDATES

(71) Applicant: VID SCALE, INC., Wilmington, DE (US)

(72) Inventors: Rahul Vanam, San Diego, CA (US); Yuwen He, San Diego, CA (US)

(21) Appl. No.: 17/421,973

(22) PCT Filed: Jan. 10, 2020
(86) PCT No.: PCT/US2020/013018

§ 371 Date: Jul. 9, 2021

Related U.S. Application Data
(60) Provisional application No. 62/791,448, filed on Jan. 11, 2019.

(51) Int. Cl. H04N 19/593; H04N 19/176; H04N 19/137; H04N 19/132; H04N 19/105; H04N 19/11

(52) U.S. Cl. CPC H04N 19/593; H04N 19/176; H04N 19/137; H04N 19/513; H04N 19/105; H04N 19/11; H04N 19/132

(57) ABSTRACT

Methods, procedures, architectures, apparatuses, systems, devices, interfaces, and computer program products for encoding/decoding data (e.g. a data stream) are provided. A video coding method for predicting a current block includes identifying a first block adjacent to the current block, the first block having motion information, performing motion compensation using the motion information to generate a set of reference samples adjacent to the current block, identifying a first line of reference samples from the set of generated reference samples to be used for intra prediction of the current block, and performing intra prediction of the current block using at least the first line of reference samples.

### BACKGROUND

The present invention relates to the field of communications and, more particularly, to methods, apparatus, systems, architectures and interfaces for communications in an advanced or next generation wireless communication system, including communications carried out using a new radio and/or new radio (NR) access technology and communication systems.

Video coding (VC) systems may be used to compress digital video signals, for example, to reduce storage needs and/or transmission bandwidth of such signals. Video coding systems may include block-based, wavelet-based, and object-based systems, and block-based hybrid video coding systems may be widely used and deployed. Block-based video coding systems include, for example, international video coding standards, such Motion Picture Experts Group (MPEG) as MPEG1/2/4 part 2, H.264/MPEG-4 part 10 Advanced Video Coding (AVC), VC-1, and High Efficiency Video Coding (HEVC) [4], which was developed by JCT-VC (Joint Collaborative Team on Video Coding) of International Telecommunication Union—Telecommunication Standardization Sector (ITU-T)/SG16/Q.6/Video Coding Experts Group (VCEG) and ISO/IEC/MPEG.

An HEVC system has been standardized, and for example, a first version of the HEVC standard may provide bit-rate saving (e.g., of approximately 50%) and/or equivalent perceptual quality compared to a prior generation video coding standard H.264/MPEG AVC. Although the HEVC standard may provide significant coding improvements over its predecessor, superior coding efficiency may be achieved with additional coding tools over HEVC. Both VCEG and MPEG initiated research and development of new coding technologies for future video coding standardization. For example, ITU-T VCEG and ISO/IEC MPEG formed the Joint Video Exploration Team (JVET) to study advanced technologies providing coding efficiency gains as compared to HEVC. Further, a software codebase, called Joint Exploration Model (JEM) has been established for future video coding exploration work. The JEM reference software was based on HEVC Test Model (HM) that was developed by JCT-VC for HEVC. Any additional proposed coding tools may need to be integrated into the JEM software, and tested using JVET common test conditions (CTCs).

### BRIEF DESCRIPTION OF THE DRAWINGS

Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating a block-based hybrid video encoding system;

FIG. 3 is a diagram illustrating a block-based video decoder;

FIG. 4 is a diagram illustrating intra prediction modes;

FIG. 5 is a diagram illustrating reference samples used to obtain prediction samples;

FIG. 6 is a diagram illustrating intra-planar prediction;

FIG. 7 is a diagram illustrating positions of neighboring spatial candidates;

FIG. 8 is a diagram illustrating blocks;

FIG. 9 is a diagram illustrating a CU according to embodiments;

FIG. 10 is a diagram illustrating determining bottom and right reference lines according to embodiments;

FIG. 11 is a diagram illustrating a CU based scheme according to embodiments;

FIG. 12 is a diagram illustrating a CU having four sub-blocks according to embodiments;

FIG. 13 is a diagram illustrating reference lines of a sub-block according to embodiments;

FIG. 14 is a diagram illustrating reference lines of a sub-block according to embodiments;

FIG. 15 is a diagram illustrating reference lines of a sub-block according to embodiments;

FIG. 16 is a diagram illustrating a flow chart for signaling a planar merge mode flag according to embodiments;

FIG. 17 is a diagram illustrating a flow chart for signaling for a CU based scheme according to embodiments;

FIG. 18 is a diagram illustrating a flow chart for signaling for an adaptive scheme according to embodiments;

FIG. 19 is a diagram illustrating a flow chart for signaling for an adaptive scheme according to embodiments; and

FIGS. 20 and 21 are diagrams illustrating intra angular prediction according to embodiments.

### EXAMPLE NETWORKS FOR IMPLEMENTATION OF THE EMBODIMENTS

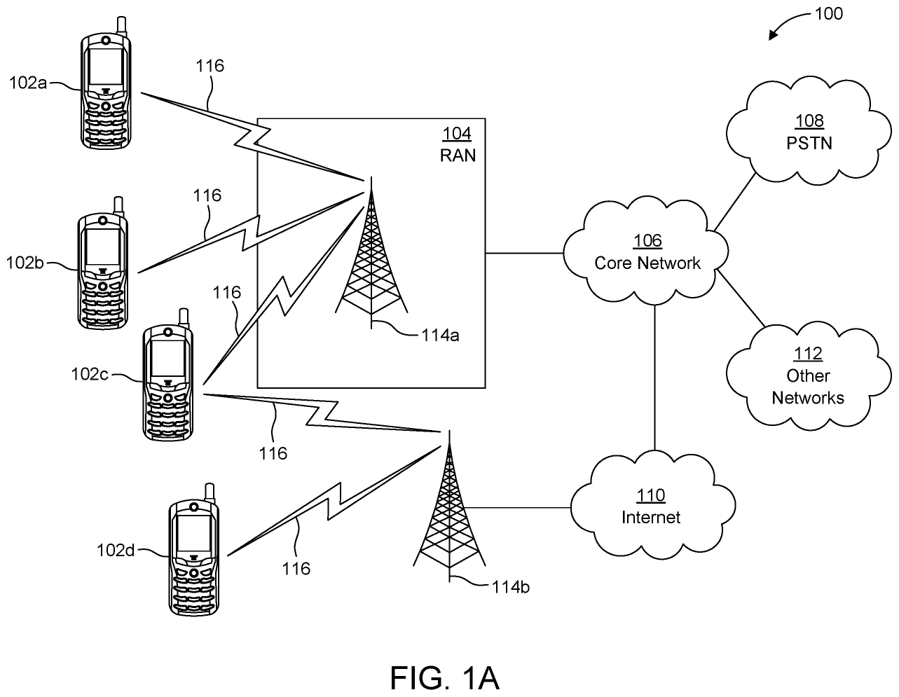

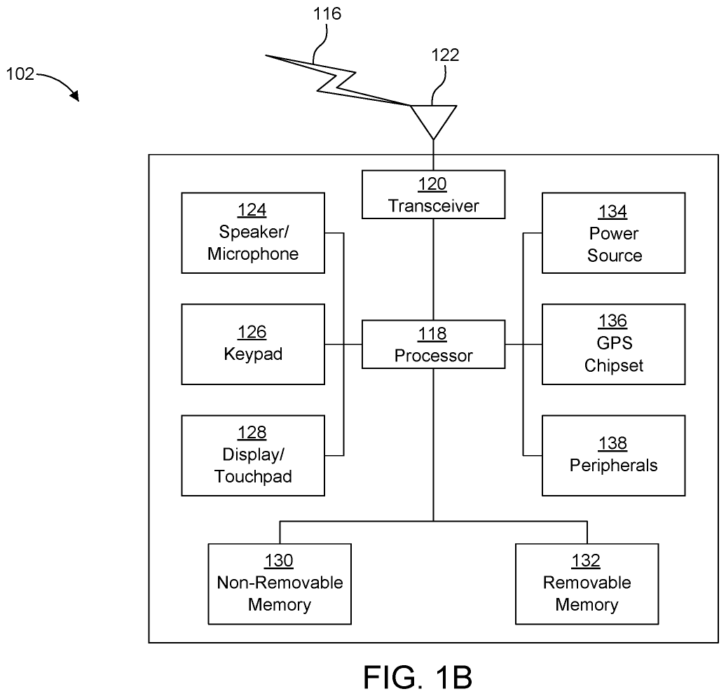

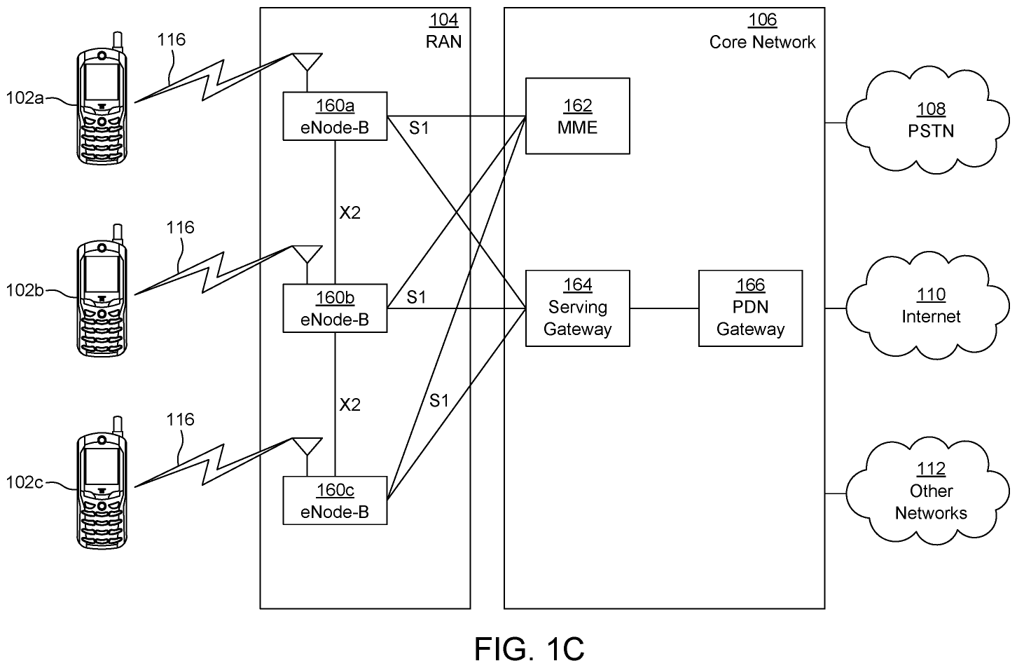

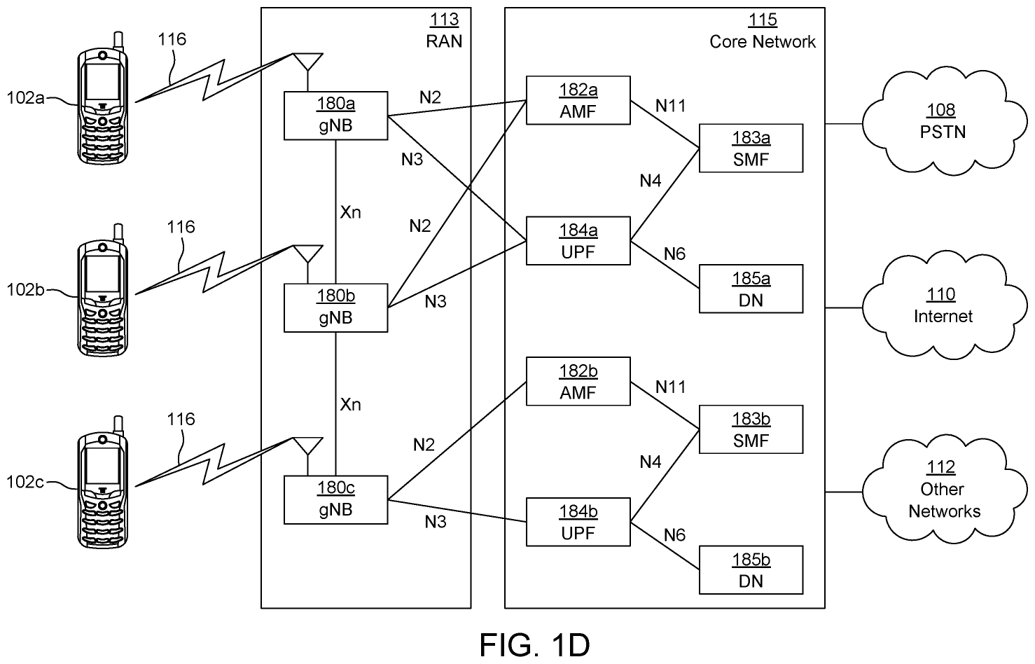

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DETAILED DESCRIPTION

### Versatile Video Coding (VVC)

Versatile Video Coding (VVC) is a (e.g., new, next generation) video coding standard. For example, VVC may refer to video coding standards having capability beyond HEVC. Research has been conducted for the standard dynamic range video content category for new video coding standards (see, e.g., 10^{th} JVET meeting), that may achieve a compression efficiency gain of approximately 40% over HEVC. Based on such evaluation results, Joint Video Expert Team (JVET) initiated development of the VVC video coding standard. Further, a reference software codebase, called VVC test model (VTM), has been established for demonstrating a reference implementation of the VVC standard. For the initial VTM-1.0, most of coding modules, including intra prediction, inter prediction, transform/inverse transform and quantization/de-quantization, and in-loop filters may follow (e.g., may be the same as, similar to, correspond to, etc.) existing HEVC design. However, VVC may be different than HEVC in that one multi-type tree based block partitioning structure may be used in the VTM.

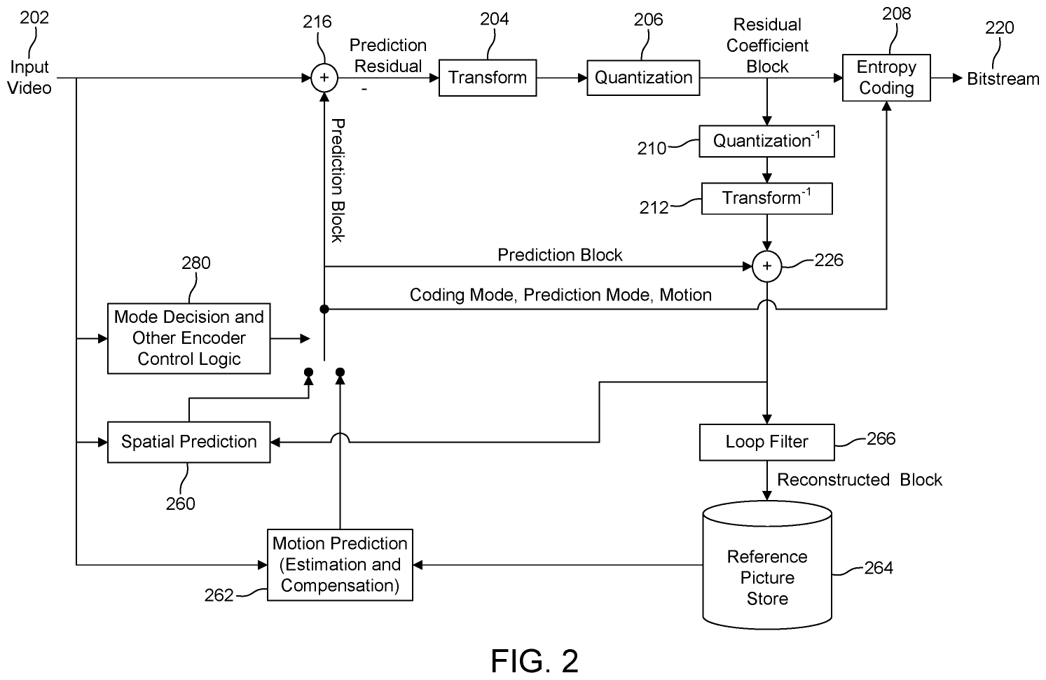

FIG. 2 is a diagram illustrating a block-based hybrid video encoding system.

Referring to FIG. 2, a block-based hybrid video encoding system 200 may be a generic block-based hybrid video coding framework. VVC may use (e.g., may have, may be based upon) a block-based hybrid video coding framework, for example, similar to HEVC. Referring to FIG. 2, an input video signal 202 may be processed according to coding units (CU). In other words, an input video signal may be processed block by block, wherein each block may be referred to as a CU.

In the case of VTM-1.0, a CU may be up to 128×128 pixels. Further, in the case of VTM-1.0, a coding tree unit (CTU) may be split into CUs based on any of a quad/binary/ternary-tree, for example, to adapt to varying local characteristics. In contrast to VTM-1.0, in the case of HEVC, blocks are partitioned only based on quad-trees. Further, the case of HEVC includes the concept of multiple partition unit types, including, for example, CUs, prediction units (PUs) and transform units (TUs). In the case of VTM-1.0, the concept of multiple partition unit type (e.g., as used in HEVC) may not be used (e.g., may be removed). That is, in the case of VTM-1.0, there may be no separation of CUs, prediction units (PUs) and transform units (TUs). In the case of VTM-1.0, each CU may be (e.g., always) used as the basic unit for any of prediction and transform (e.g., for both PUs and TUs) without further partitions. In the case of multi-type tree structure, a (e.g., one) CTU may be (e.g., firstly) partitioned by a quad-tree structure. Then, each quad-tree leaf node may be (e.g., further) partitioned by any of a binary and ternary tree structure.

Referring to FIG. 2, spatial prediction 260 and/or temporal prediction 262 may be performed. Spatial prediction (e.g., also referred to as intra-prediction) may predict a current video block using pixels from samples of already coded neighboring blocks (e.g., also referred to as reference samples) in a same video picture/slice. Spatial prediction may reduce spatial redundancy, which may be inherent in a video signal. Temporal prediction (e.g., also referred to as inter-prediction or motion compensated prediction) may predict a current video block using reconstructed pixels from the already coded video pictures. Temporal prediction may reduce temporal redundancy, which may be inherent in a video signal. A temporal prediction signal for a given CU may be (e.g. is usually) signaled by one or more motion vectors (MVs). A MV may indicate any of an amount and direction of motion between the current CU and its temporal reference. In a case where multiple reference pictures are supported, a (e.g., one) reference picture index may be additionally sent, for example, to identify a reference picture in the reference picture store 264 from which the temporal prediction signal comes.

Referring to FIG. 2, mode decision 280 (e.g., disposed/performed in an encoder) may choose (e.g., select, determine, etc.) a best prediction mode. For example, after spatial and/or temporal prediction, mode selection may be used to determine the best prediction mode according to a rate-distortion optimization method. A prediction block may (e.g., then) be subtracted from a current video block 216 and a prediction residual may be de-correlated using a transform 204 and may be quantized 206 to generate quantized residual coefficients. The quantized residual coefficients may be inverse quantized 210 and inverse transformed 212 to form a reconstructed residual, which may (e.g., then) be added back to the prediction block 226, for example, to form a reconstructed signal of a CU.

In-loop filtering 266 (e.g., further in-loop filtering; such as a deblocking filter) may be applied on the reconstructed CU, for example, before it is put in a reference picture store 264 and in-loop filtered reconstructed samples may be used to code future video blocks. An output video bit-stream 220 may be formed by sending, to an entropy coding unit 208, any of: a coding mode (e.g., inter or intra), prediction mode information, motion information, and quantized residual coefficients. The entropy coding unit 208 may (e.g., further) compress and pack any of a coding mode (e.g., inter or intra), prediction mode information, motion information, and quantized residual coefficients to form the bit-stream.

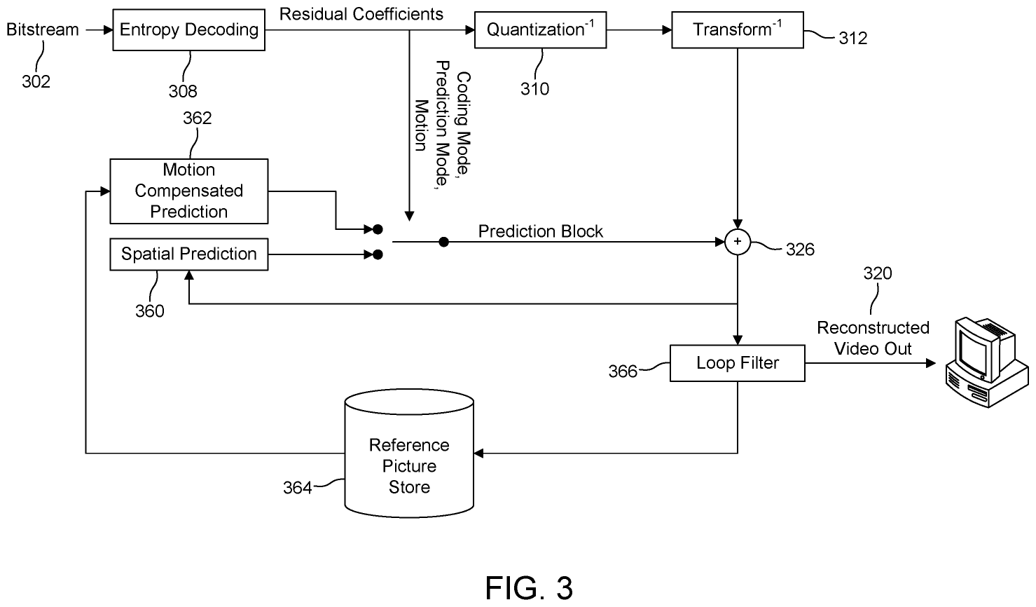

FIG. 3 is a diagram illustrating a block-based video decoder.

Referring to FIG. 3, a (e.g., general) block-based video decoder 300 may receive (e.g., read, be inputted with, etc.) a video bit-stream 302. The video bit-stream 302 may be (e.g., first) unpacked and may be entropy decoded at entropy decoding unit 308. A coding mode and prediction information may be provided to (e.g., are sent to) any of a spatial prediction unit 360 (e.g., in a case of intra-coding) or a temporal prediction unit 362 (e.g., in a case of inter-coding), for example, to form a prediction block.

Residual transform coefficients may be provided (e.g., are sent) to any of inverse quantization unit 310 and inverse transform unit 312, for example, to reconstruct the residual block. The prediction block and the residual block may be (e.g., then) added together at block (e.g., adder) 326. The reconstructed block may (e.g., further) go through in-loop filtering before it is stored in reference picture store 364. The reconstructed video (e.g., that is stored in the reference picture store 364) may be provided (e.g., sent out, used, etc.) to drive a display device, and may be used to predict future video blocks.

In subsequent versions of VTM, new coding tools have been progressively integrated. For example, coding modes for predicting chroma from luma are included in VTM. Further, technologies for predicting chroma from luma are also under investigation and are further discussed below.

### Intra Prediction

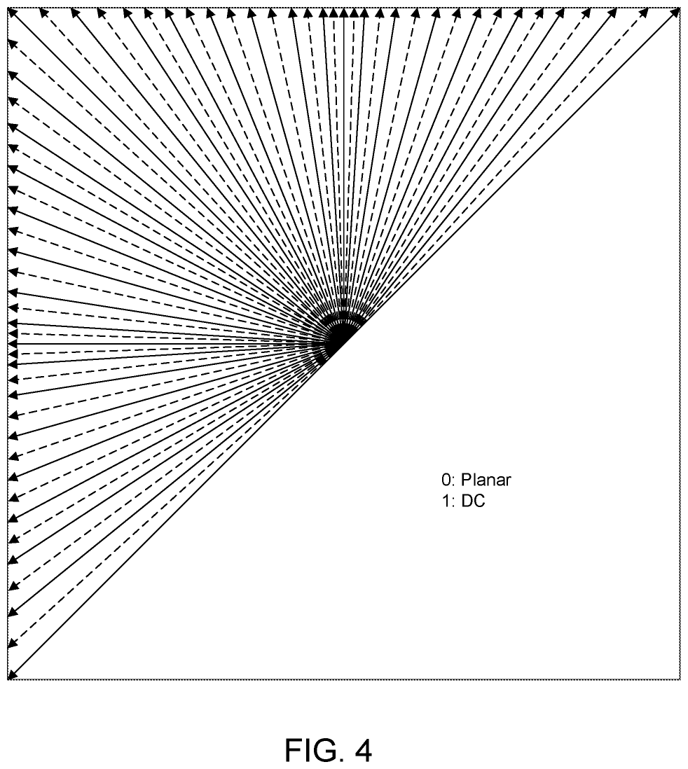

FIG. 4 is a diagram illustrating intra prediction modes.

Intra prediction in VTM may include a plurality of angular modes (e.g., 65 angular modes), and may also include any of non-angular planar modes and non-angular DC modes. Both the non-angular planar and DC modes may be the same as in HEVC.

Referring to FIG. 4, among the 65 angular modes, 33 angular modes are the same as in the HEVC and 32 angular modes differ from those of HEVC (e.g., as depicted by solid black lines with arrows). The angular modes, which may be referred to as directional modes, may be applied to all block sizes for both luma and chroma intra predictions. In a case of non-square blocks, several conventional angular modes may be adaptively replaced with wide angle intra prediction modes. In a case of using the DC mode for non-square blocks, only the longer side may be used for computing the average.

### Intra-Planar Prediction

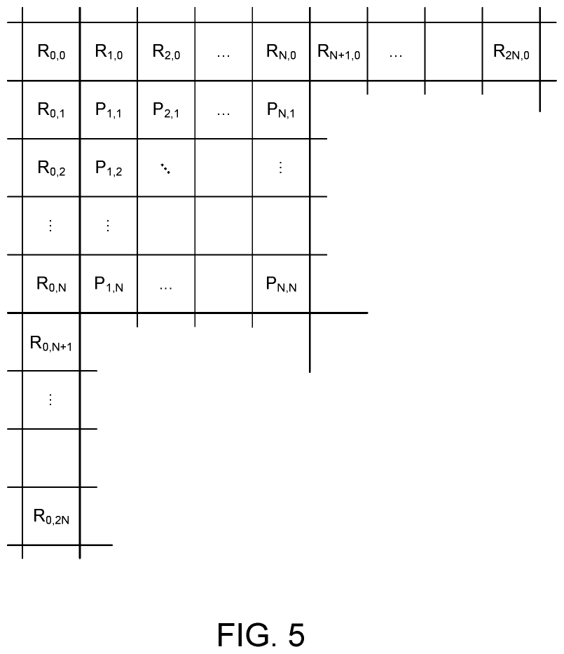

FIG. 5 is a diagram illustrating reference samples used to obtain prediction samples.

A planar mode may provide a prediction of order one. Planar mode may be (e.g., essentially) for a prediction of order one, and, for example, may predict a block by using a bilinear model derived from top and left reference samples (e.g., reference samples located top and left adjacent to the CU), for example, as shown in FIG. 5. The planar mode operation may include computing two linear predictions, and averaging them as shown in Equations 1-3, as follows:

P_{x,y}^{v}=(H−y)·R_{x,0}+y·R_{0,N+1} [Equation 1];

P_{x,y}^{h}=(W−x)·R_{0,y}+x·R_{N+1.0} [Equation 2];

P_{x,y}=9P_{x,y}^{v}<<log₂(W)+P_{x,y}^{h}<<log₂(H)+WH)>>(log₂(W)+log₂(H)+1) [Equation 3].

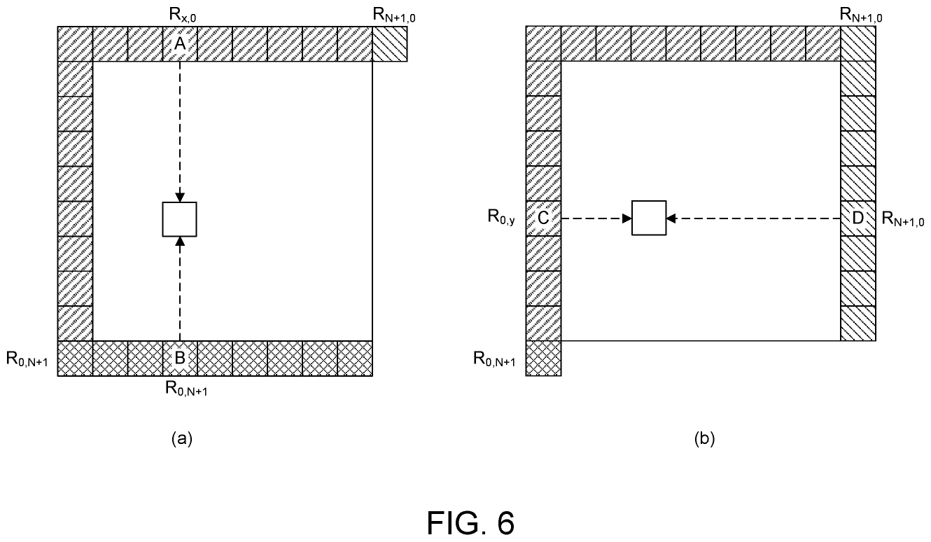

FIG. 6 is a diagram illustrating intra-planar prediction.

The prediction operation of Equation 1 is illustrated in part (a) of FIG. 6. The bottom reference line is obtained by replicating the bottom-left sample R_{0,N+1}. The top and bottom reference lines are interpolated to generate prediction samples P_{x,y}^{v} using Equation 1. The right reference column is generated by replicating the top-right pixel R_{N+1,0} as shown in part (b) of FIG. 6. The prediction operation in Equation 2 involves linear interpolation of the left and right reference columns to generate predictions P_{x,y}^{h}. The two predictions P_{x,y}^{v} and P_{x,y}^{h} are averaged as in Equation 3 to generate a (e.g., final) prediction block.

### Merge Mode in HEVC

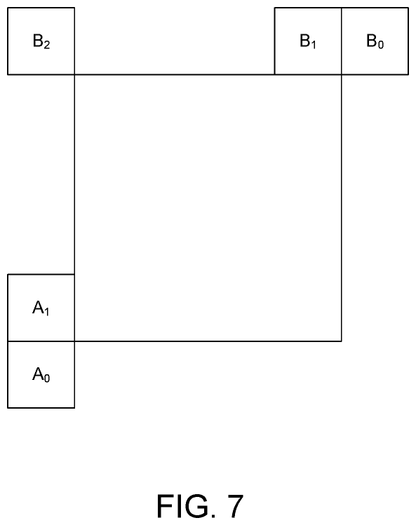

FIG. 7 is a diagram illustrating positions of neighboring spatial candidates.

In the HEVC standard, the set of possible candidates in the merge mode may be composed of any number of spatial neighboring candidates, a (e.g., one) temporal neighboring candidate, and any number of generated candidates. Referring to FIG. 7, positions of five spatial candidates are shown.

A list of merge candidates may be constructed by (e.g., first) checking the five spatial candidates and adding them to the list in the order A1, B1, B0, A0 and B2. In a case where a block located at a (e.g., one) spatial position is any of intra-coded and outside a boundary of a current slice, the block may be considered as unavailable. Any redundant entries wherein candidates have the same motion information as an existing candidate may be (e.g., also) excluded from the list, for example, to remove the redundancy of the spatial candidates.

A temporal candidate may be generated and included in the merge candidate list. That is, after including all valid spatial candidates in the list of merge candidates, a temporal candidate may be generated from motion information of a co-located block in a co-located reference picture, for example, by using a temporal motion vector prediction (TMVP) technique. Additionally, in the HEVC standard, a size N of the merge candidate list may be set to 5. In a case where the number of merge candidates (e.g., including spatial and/or temporal candidates) is larger than N, only the first N−1 spatial candidates and the temporal candidate may be kept in the list. Otherwise, in a case where the number of merge candidates is smaller than N, several combined candidates and zero candidates may be added to the candidate list until the number of candidates reaches the size N.

### Sub-block Based Temporal Motion Vector Prediction (SbTMVP)

VTM-3.0, which is an update to VTM-1.0, includes a subblock-based temporal motion vector prediction (SbTMVP) method. Similar to the TMVP method, SbTMVP may use: (1) a motion field in a collocated picture, for example, to improve motion vector prediction; and (2) a merge mode for CUs in a current picture. SbTMVP may also use the same collocated picture used by TMVP. However, there are the two main aspects in which SbTMVP may differ from TMVP: (1) TMVP predicts motion at the CU level, while SbTMVP predicts motion at the sub-CU level (e.g., the sub-CU size in SbTMVP may be fixed to 8×8); and (2) TMVP may fetch temporal motion vectors from a collocated block (e.g., a bottom-right block or a center block relative to the current CU) in the collocated picture. That is, SbTMVP may apply a motion shift before fetching the temporal motion information from the collocated picture. In such a case, the motion shift may be obtained from the motion vector belonging to one of the spatial neighboring blocks of the current CU.

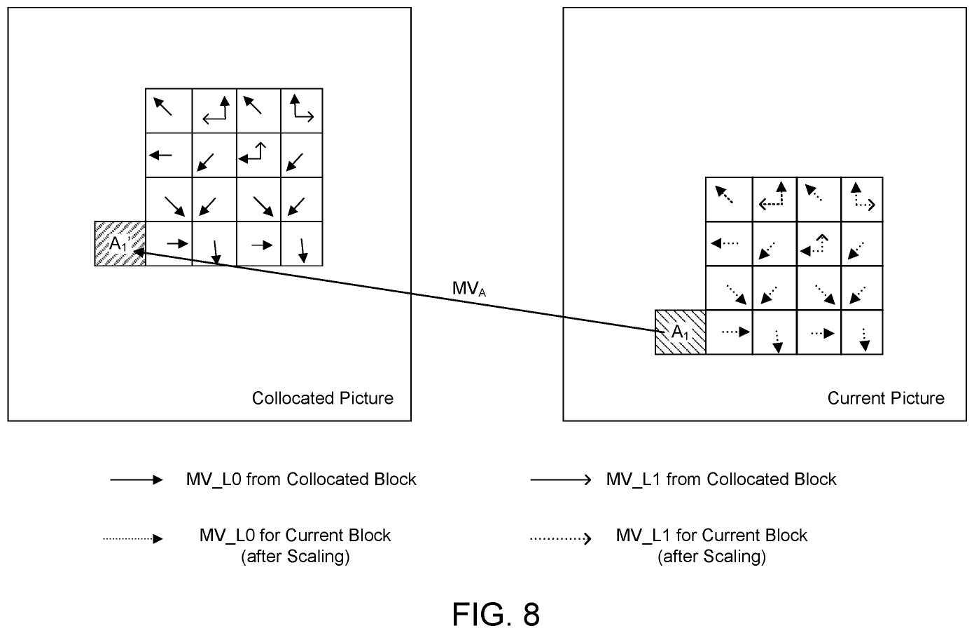

FIG. 8 is a diagram illustrating blocks.

Referring to FIG. 8, the SbTMVP process may predict motion vectors of sub-CUs within a current CU using the following two steps. Step 1: the spatial neighbors (shown in FIG. 7) are examined in the order of A1, B1, B0 and A0; the first spatial neighboring block that has a motion vector that uses the collocated picture as its reference picture is encountered and/or identified, such motion vector is selected to be the motion shift to be applied; and, if no such spatial neighbor exists for the given CU, then the motion shift is set to (0, 0). In the scenario illustrated by the left half of FIG. 8, A1 is the spatial neighboring block which provides the selected motion shift. Step 2: the motion shift (e.g., obtained in step 1) is applied (e.g. added to the current block's coordinates) to obtain sub-CU-level motion information (e.g., including motion vectors and reference indices) from the collocated picture. For example, the right half of FIG. 8 illustrates the applied motion based on assuming the motion shift is set to A1's motion. The motion information of each sub-CU is derived using the motion information of its corresponding block in the collocated picture.

In a case where the motion information of the collocated sub-CU is identified (e.g., upon such information being identified), the motion information may be converted to the motion vectors and reference indices of the current sub-CU. For example, the motion information may be converted in a similar way as the TMVP process of HEVC, where temporal motion scaling is applied to align the reference pictures of the temporal motion vectors to those of the current CU.

### Inter and Intra Combined Merge Mode

The inter and intra combined merge mode combines an intra prediction with a merge indexed prediction. For a merge CU, a flag that signals true indicates that an intra mode must be selected from an intra candidate list. For a luma component, the intra candidate list may be derived from four intra modes including DC, planar, horizontal, and vertical modes; and the size of the list may be three or four, for example, depending on the block shape.

In a case where the CU width is larger than twice the CU height, the horizontal mode may be excluded from the intra mode list, and similarly, when the CU height is larger than twice the CU width, vertical mode may be excluded from the intra mode list. An intra prediction mode selected by the intra mode index and a merge indexed prediction selected by the merge index are (e.g., then) combined using weighted average. In a case where DC or planar mode is selected, or in a case where the CB width or height is smaller than 4, equal weights may be chosen. For a chroma component, direct mode (DM) may be (e.g., always) applied without additional signaling.

In the intra planar mode, samples within a PU may be interpolated using reference samples along boundaries, including the left, right, top, and bottom boundaries, adjoining a PU. In a case where the right and bottom neighboring PUs have not yet been encoded, the associated right and bottom reference lines are not available. Instead the associated right and bottom reference lines may be predicted by replicating the samples on the top-right and bottom-left of the PU, respectively, as shown in parts (a) and (b) of FIG. 6. There may be a problem that such coarse approximations may yield poor prediction, and may (e.g., thereby) impact the overall compression performance.

### Planar Merge Mode

According to embodiments, a planar merge mode may include features of any of intra-planar prediction and inter-merge mode. According to embodiments, improved intra planar prediction schemes for intra CUs in inter-pictures may be provided, for example, to improve compression performance. According to embodiments, improved intra planar prediction schemes for intra CUs in inter-pictures may improve approximations that were previously coarse approximations that yield poor prediction and impact compression performance. According to embodiments, motion information from a spatial neighborhood of a (e.g., given) intra CU may be used to derive right and bottom reference lines. According to embodiments, in inter-pictures, these temporally derived reference samples may be highly correlated to the actual samples, and, for example, may improve the accuracy of intra-planar prediction.

According to embodiments, any of a CU based scheme, a sub-block based scheme, and a modified intra-planar scheme may be used, for example, to improve accuracy of intra-planar prediction in inter pictures. According to embodiments, a CU based scheme for deriving one or more reference lines may include using the motion information from spatial neighbors. According to embodiments, a sub-block based scheme for deriving one or more reference lines of a sub-block may include using motion information obtained from the SbTMVP process. According to embodiments, a modified intra-planar scheme may use the (e.g., new) reference lines generated by the CU based and sub-block based schemes for intra planar prediction at any of a CU level or a sub-block level.

### CU Based Approach

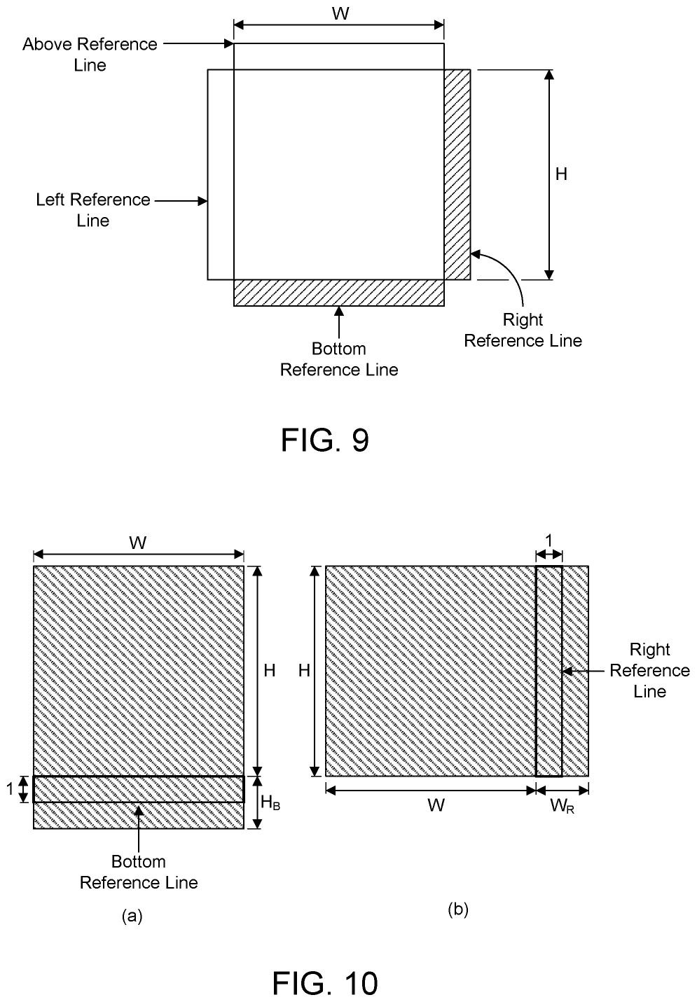

FIG. 9 is a diagram illustrating a CU according to embodiments. FIG. 10 is a diagram illustrating determining bottom and right reference lines according to embodiments.

According to embodiments, in a CU based scheme, right and bottom reference lines of an intra CU may be derived using motion information of spatial neighbors. Referring to FIG. 9, a CU may have width W and height H. According to embodiments, top and left reference lines may be obtained using an approach similar to (e.g., the same) as that in intra planar mode, as described hereinabove. According to embodiments, bottom and right reference lines, for example, of the CU shown in FIG. 9, may be predicted as described below with respect to performing (1) a bottom reference line prediction and (2) a right reference line prediction.

According to embodiments, in the case of a bottom reference line prediction, an availability of a left candidate A1 is (e.g., first) checked and (e.g., next) an availability of a bottom-left candidate A0 may be checked. According to embodiments, motion information of the first available candidate may be chosen, and may be used for temporally predicting a block of size W×(H+HB) by motion compensation, wherein HB may be greater than or equal to one, as illustrated in part (a) of FIG. 10. According to embodiments, a horizontal line at the (H+1) row may be (e.g., then) chosen as the bottom reference line, for example, in a case of assuming that rows are indexed from the top row beginning with index one.

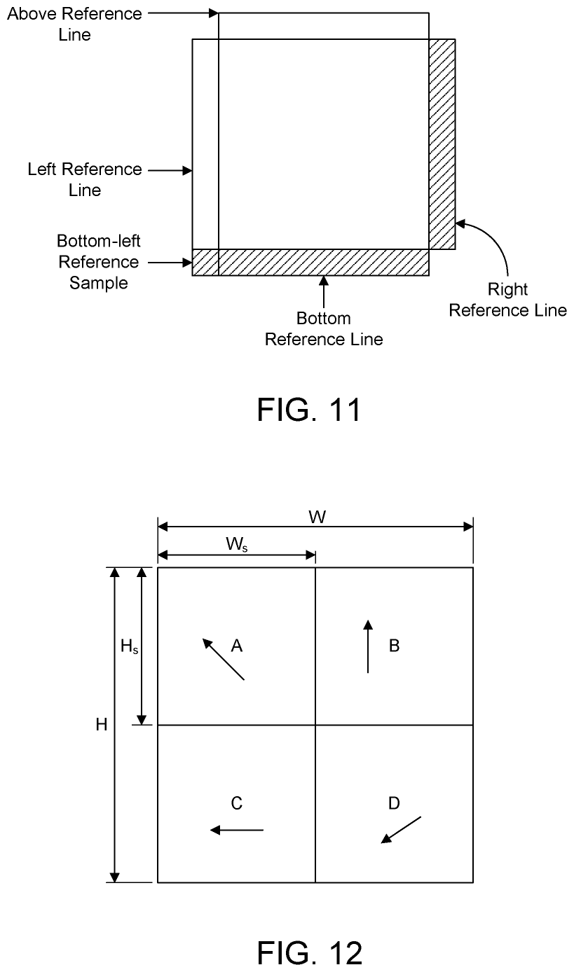

According to embodiments, in the case of a right reference line prediction: an availability of an above spatial candidate B1 may be (e.g., first) checked and (e.g., next) an availability of the above-right candidate B0 may be checked. According to embodiments, motion information of the first available candidate may be chosen, and may be used to temporally predict a block of size (W+WR)×H by motion compensation, wherein WR may be greater than or equal to one, as illustrated in part (b) of FIG. 11. According to embodiments, a vertical line at the (W+1) column may be chosen as the right reference line, for example, in case of assuming that columns are indexed from the left beginning with index one.

According to embodiments, in a case where no A0, A1, B0, or B1 candidates are available, then other spatial and temporal CU merge candidates may be considered. According to embodiments, in a case where no CU level merge candidates are available, planar merge mode may be disabled for a given CU. According to embodiments, in a case where (e.g., only) one candidate is available (e.g. only A1), then a reference line with no candidates (e.g. the right reference line) may use the same motion information as the available candidate. According to embodiments, a planar merge mode may be disabled if any of the above candidates and left candidates are unavailable. For example, in a case where A0 and A1 are both unavailable, the planar merge mode may be disabled for the given CU. According embodiments, an order of checking of the available spatial candidates may be modified; for example, candidate A0 may be checked before candidate A1, and/or candidate B0 may be checked before candidate B1

FIG. 11 is a diagram illustrating a CU based scheme according to embodiments.

According to embodiments, in another CU-based approach, the reference line that is motion derived may be adaptively selected by the encoder. For example, according to embodiments, for certain CUs, an encoder may choose (e.g., may determine, may be configured, etc.) to derive any of (e.g., both) the right and bottom reference lines using the motion derived scheme described above. According to embodiments, for other CUs, the encoder may use motion derivation for one of the reference lines (e.g. right reference line), and may use the intra planar approach (e.g. replication of an available reference sample) for deriving the other reference line (e.g. bottom reference line), as illustrated in FIG. 11. According to embodiments, such an approach may use (e.g., need, require) signaling; discussion regarding (e.g., such, additional, etc.) signaling may be found further below.

According to embodiments, in the case of the inter and intra combined merge mode described above, the intra mode candidate list may be modified to contain the planar merge mode. According to embodiments, the planar merge mode may replace the original planar mode in the list. According to embodiments, in a case where the number of intra candidates is less than four, for example, due to the CU dimensions, the planar merge mode may be added to the list, for example, without replacing the original planar mode. According to embodiments, in such a case, the planar merge mode may be placed after the original planar mode in the candidate list. According to embodiments, in a case where the planar merge mode index is signaled, planar merge mode prediction may be combined with merge indexed prediction using any of equal and unequal weighting.

### Sub-Block Based Approach

FIG. 12 is a diagram illustrating a CU having four sub-blocks according to embodiments.

According to embodiments, in a sub-block based scheme, a CU may be composed of sub-blocks, and planar prediction may be performed for each sub-block. According to embodiments a planar prediction for each sub-block may be performed by (e.g., first) determining its associated right and bottom reference lines. Referring to FIG. 12, a CU may have (e.g., include, be composed of, etc.) four sub-blocks, labeled ‘A’, ‘B’, ‘C’, and ‘D’, each of size W_{S}×H_{S}. According to embodiments, a sub-block size may be set to 8×8, which is the same as the sub-CU size in VTM. According to embodiments, for each sub-block, the motion information may be determined using the SbTMVP process described above.

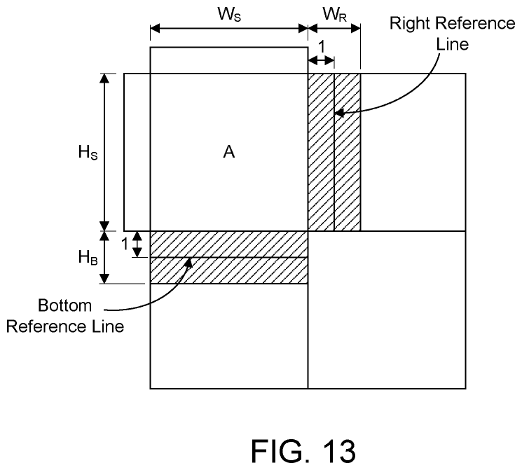

FIG. 13 is a diagram illustrating reference lines of a sub-block according to embodiments.

According to embodiments, for sub-block ‘A’, as shown in FIG. 13, the SbTMVP derived sub-block motion information may be used for predicting a block of size (W_{S}+W_{R})×(H_{S}+H_{B}) using motion compensation. According to embodiments, the right and bottom reference lines may be (e.g., then) obtained by selecting the (W_{S}+1) column and (H_{S}+1) row from the predicted block, respectively, for example, as shown in FIG. 13. According to embodiments, dimensions WR and HB may be greater than or equal to one.

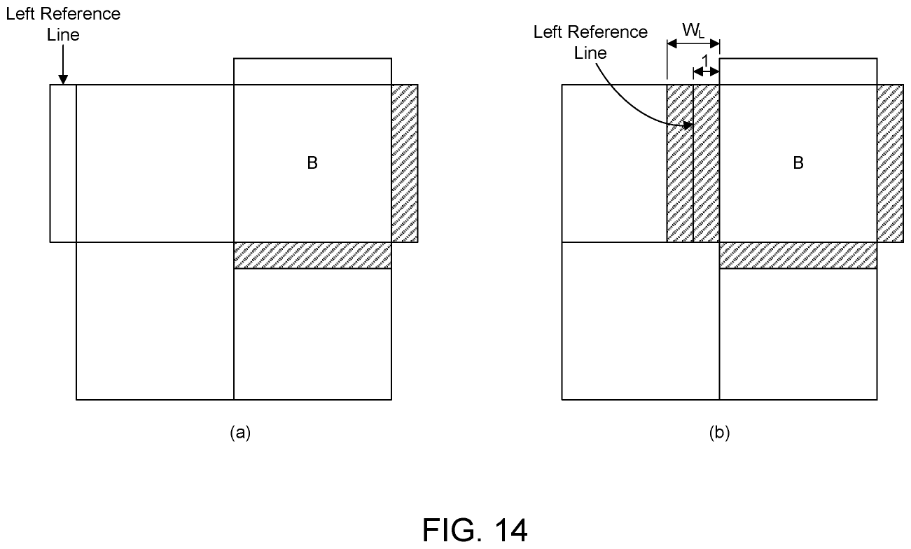

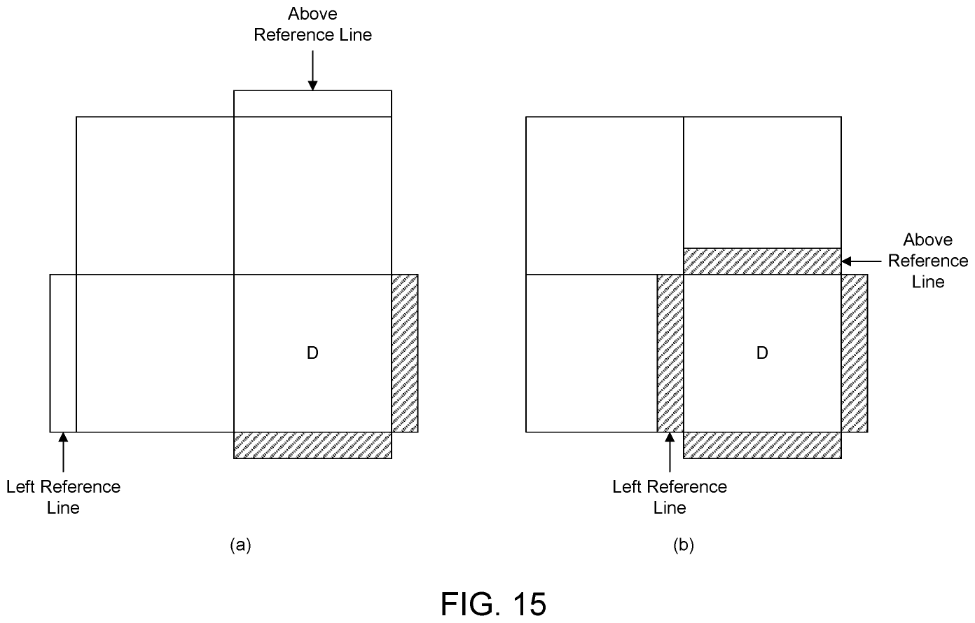

FIG. 14 is a diagram illustrating reference lines of a sub-block according to embodiments.

According to embodiments, for a sub-block ‘B’, associated right and bottom reference lines may be derived according to a process similar to a process as described above with reference to sub-block ‘A’. For example, as shown in part (a) of FIG. 14, the same left reference line as used by ‘A’ may be used for sub-block ‘B’, however, such reference line may be far (e.g., farther) away from ‘B’. According to embodiments, the left reference line may be derived using sub-block motion information, for example, so that a resulting left reference line is adjacent to sub-block ‘B’, as shown in part (b) of FIG. 14. According to embodiments, in such a case during motion compensation, a larger block of size (W_{L}+W_{S}+W_{R})×(H_{S}+H_{B}) may be obtained, and the left reference line may be (e.g., then) selected.

FIG. 15 is a diagram illustrating reference lines of a sub-block according to embodiments.

According to embodiments, for sub-block ‘D’, left and above reference lines may be used as illustrated in part (a) of FIG. 15, for example, where they are located farther away from the sub-block. According to embodiments, left and above reference lines may (e.g., also) be derived using motion information, for example, thereby resulting in reference lines that are adjacent to the sub-block, as illustrated in part (b) of FIG. 15.

According to embodiments, to reduce the memory access bandwidth for any (e.g., both) of CU and sub-block based approaches, the motion vector used to derive the right and bottom reference samples for planar prediction may be rounded to integer motion. According to embodiments, (e.g., only) uni-prediction may be used to generate (e.g., such) reference samples, for example, even when the inter merge candidate is bi-prediction. As another example, according to embodiments, the reference picture in two lists closer to the current picture may be selected for motion compensation. In such a case, integer motion and uni-prediction may be combined, for example, to reduce the memory bandwidth further.

### Modified Intra Planar Prediction

According to embodiments, modified intra planar prediction may be performed, for example, after the right and bottom reference samples are determined according to embodiments described above. According to embodiments, samples within a CU may be predicted as according to the following Equations 4-6:

P_{x,yphu v}=(H−y)·R_{x,o}+y·Bottomₓ, [Equation 4];

P_{x,y}^{h}=(W−x)·R_{0,y}+x·Right_{y}, [Equation 5];

P_{x,y}=(P_{x,y}^{v}<<log₂(W)+P_{x,y}^{h}<<log₂(H)+WH)>>(log₂(W)+log₂(H)+1) [Equation 6];

wherein Right and Bottom are right and bottom reference lines, respectively. Other notations in Equations 4-6 may be the same as those described above.

### Signaling for a New Planar Mode

According to embodiments, a planar merge mode may be applied to (e.g., restricted to only) the luma component. According to embodiments, a planar merge mode may be applied to both the luma and chroma components. According to embodiments, in a case where the planar merge mode is restricted to only the luma component, a direct mode (DM) in chroma may only use a regular planar mode, although the associated luma block may use the planar merge mode.

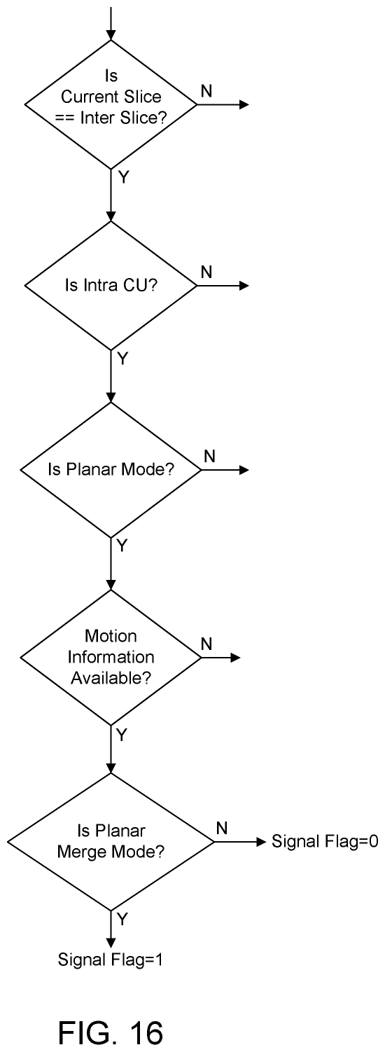

FIG. 16 is a diagram illustrating a flow chart for signaling a planar merge mode flag according to embodiments.

According to embodiments, a flag associated with a planar merge mode may be signaled. According to embodiments, a flag associated with a planar merge mode may be signaled in a case where conditions are satisfied. For example, referring to FIG. 16, the planar merge mode flag may be signaled according to (e.g., based on) any (e.g., all) of the following conditions being satisfied: (1) a current slice is an inter slice (P-slice or B-slice); (2) a current CU is an intra CU; (3) intra mode is planar mode; and (4) neighboring motion information is available.

According to embodiments, for the CU based scheme discussed above, the last condition above (e.g., condition 4) may check (e.g., determine) if spatial neighboring candidates are available. According to embodiments, such a check (e.g., determination) may be performed in a case where both of an above spatial candidate (e.g., at least one of B0 or B1) and a left spatial candidate (e.g., at least one of A0 or A1) are available. According to embodiments, a check (e.g., determination) may be performed in a case where any (e.g., one) spatial candidate is available.

According to embodiments, for the sub-block-based scheme described above, the last condition (e.g., condition 4) may check if valid motion information is available for deriving the sub-block motion information. According to embodiments, in a case where all the above conditions are satisfied, the planar merge flag may be signaled. According to embodiments, in a case where the planar merge mode is enabled, a CU-level flag equal to one may be signaled in the bitstream, and otherwise, a CU-level flag equal to zero may be signaled in the bitstream.

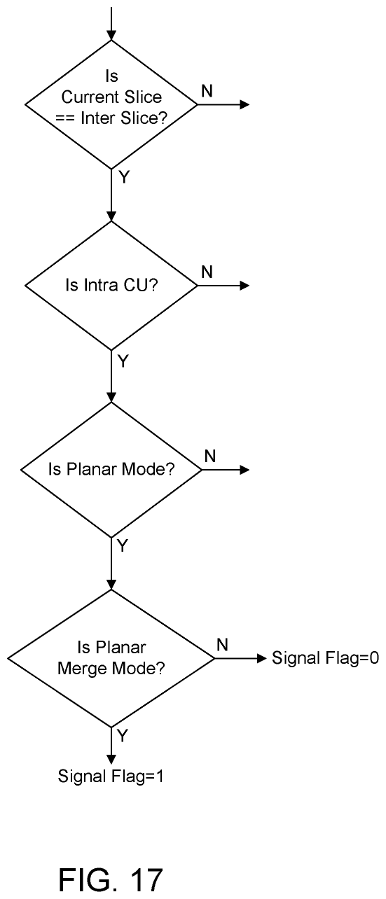

FIG. 17 is a diagram illustrating a flow chart for signaling a planar merge mode flag according to embodiments.

According to embodiments, a CU-level flag may be signaled in a case where any number of conditions (e.g., more or less than the number of conditions shown in FIG. 16) are satisfied. For example, referring to FIG. 17, a planar merge mode flag may be sent upon satisfying three conditions.

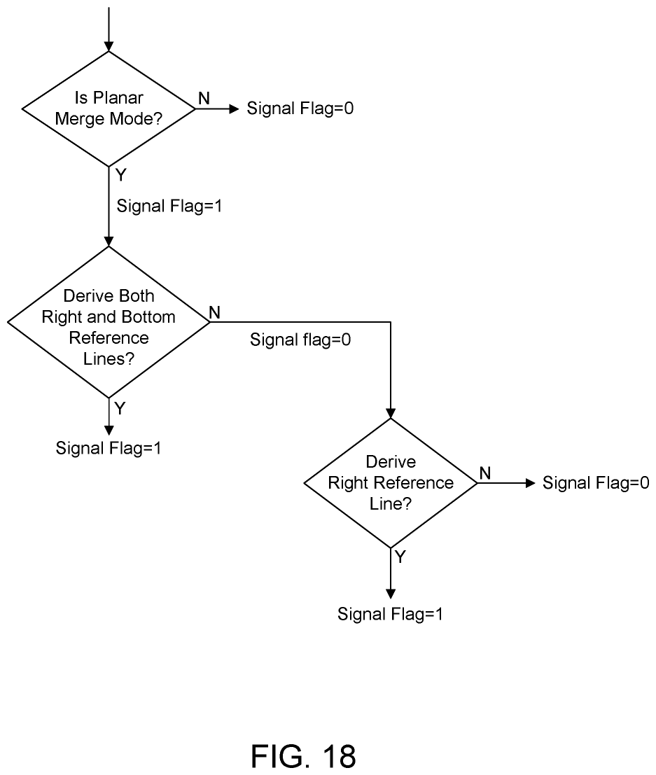

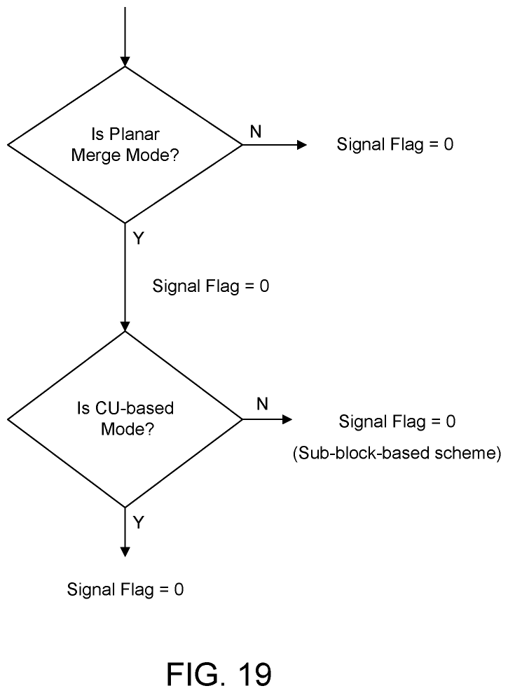

FIG. 18 is a diagram illustrating a flow chart for signaling for a CU based scheme according to embodiments.

According to embodiments, a CU-based scheme may adaptively select reference lines that are to be derived using motion information according to embodiments described above. According to embodiments, the CU-based scheme may use (e.g., need, require) signaling to indicate any of right, bottom, or both reference lines that may be (e.g., are to be) derived, as shown in FIG. 18. According to embodiments, this CU-based scheme may increase a number of CU-level flags that may be signaled to three.

FIG. 19 is a diagram illustrating a flow chart for signaling for an adaptive scheme according to embodiments.

According to embodiments, for each CU, the encoder may adaptively select any of CU-based and sub-block-based approaches, for example, based on a rate distortion cost. According to embodiments, such adaptive scheme may use (e.g., need, require, etc.) an additional CU-level flag to be signaled, as shown in FIG. 19. According to embodiments, one value of the flag (e.g. flag=1) may indicate the CU based approach, and the other value of the flag (e.g. flag=0) may indicate the sub-block based approach.

### Mode Selection at the Encoder

According to embodiments, an encoder may always include the planar merge mode as a candidate during intra mode selection using the rate distortion (RD) cost. According to embodiments, the planar merge mode may be initially compared with other intra modes using the Sum of Absolute Transformed Difference (SATD) cost, for example, for selecting a subset of candidate modes that are to be further compared using the RD cost. During such initial candidate selection process (e.g., selecting of the subset of candidate modes), the planar merge mode may yield higher SATD cost, and, for example, may not be selected for further testing using the RD cost.

### Improving Intra Angular Prediction

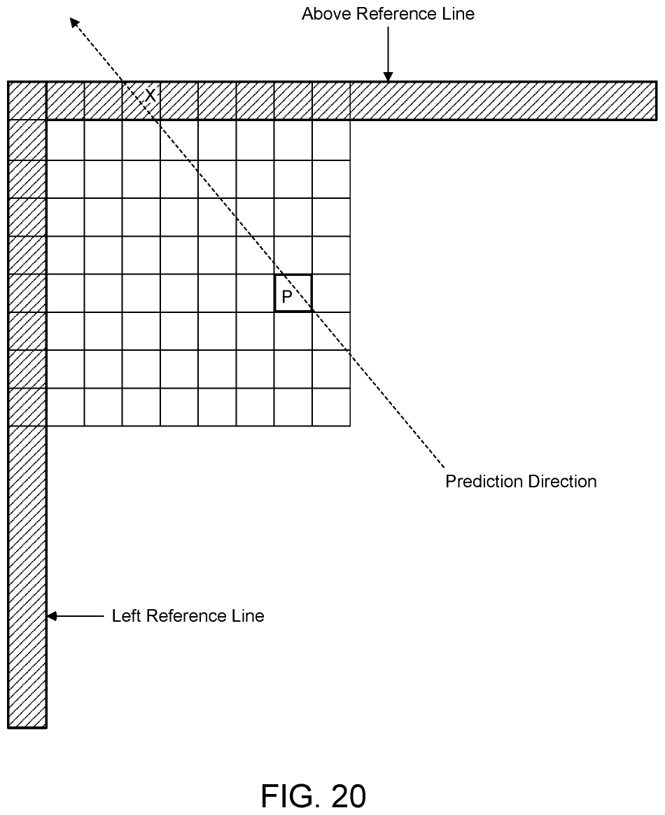

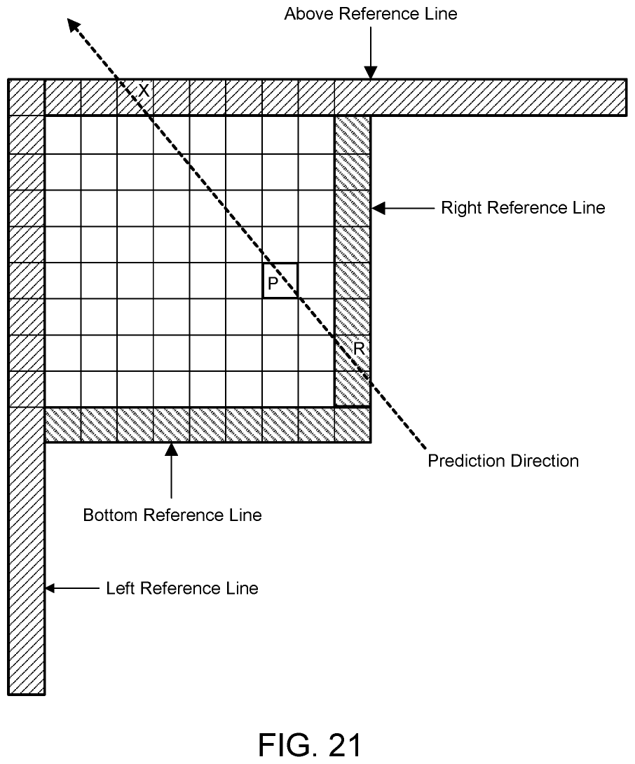

FIGS. 20 and 21 are diagrams illustrating intra angular prediction according to embodiments.

According to embodiments, for intra angular prediction, samples from above and/or left reference lines may be used for predicting samples within a CU. For example, as shown in FIG. 20, in a case of a (e.g., certain) prediction direction, a sample ‘P’ in the CU may be predicted using a sample ‘X’ on (e.g., from) the above reference line. In a case of larger CUs, there may be lower accuracy for intra angular prediction of samples that are closer to the right and bottom boundaries, for example, because they are farther away from the top and left reference lines. According to embodiments, right and bottom reference lines may be predicted according to embodiments described above, and as illustrated in FIG. 21.

According to embodiments, samples in a CU may be predicted by performing a weighted average of samples belonging to the above/left reference line and samples belonging to the right/bottom reference line. An illustration is provided in FIG. 21. For example, according to embodiments, a sample ‘P’ may be predicted by weighted averaging the above reference sample ‘X’ and the right reference sample ‘R’. According to embodiments, a location of the reference sample ‘R’ may be determined by (e.g., according to, based on, etc.) the prediction direction (e.g. a selected directional intra prediction mode) and the position of sample ‘P’. In a case where a location of the reference sample ‘R’ lies on (e.g., has, is at, etc.) a fractional sample position, its value may be interpolated from neighboring reference samples. According to embodiments, the weights used for averaging ‘X’ and ‘R’ may be chosen, for example, based on their relative distance from sample ‘P’, or equal weights may be chosen. According to embodiments, the intra angular mode described herein may also be referred to as an angular merge mode.

According to embodiments, signaling for an angular merge mode may be similar to signaling for a planar merge mode as described above. According to embodiments, a flag (e.g., for signaling an angular merge mode) may be signaled according to (e.g., satisfaction of) any of the following conditions: (1) a current slice is an inter slice (e.g., P-slice or B-slice); (2) a current CU is an intra CU; (3) the intra mode is an angular mode; and (4) neighboring motion information is available. According to embodiments, the flag may be set to one, for example, in a case where an angular merge mode is chosen, otherwise the flag may be set to zero, or vice versa.

According to embodiments, signaling overhead may be reduced. According to embodiments, angular merge mode may be applied to larger CUs, for example, those having a width and/or a height exceeding a (e.g., certain) threshold. According to embodiments, a threshold value for applying angular merge mode may be predetermined, configured, calculated, etc. According to embodiments, the angular merge mode may be restricted to CUs whose area (e.g., width multiplied by height) exceeds a threshold. According to embodiments, a threshold value for restricting application of the angular merge mode may be predetermined, configured, calculated, signaled, etc.

According to embodiments, DC mode may be improved using right and bottom reference lines that may be derived from neighboring motion information, for example similar to the planar merge mode. According to embodiments, in the case of DC mode, the DC predicted samples may be the average of the samples in the left, above, right, and bottom reference lines. According to embodiments, for non-square CUs, an average of the two longer reference lines (e.g., either: (1) above and bottom reference lines; or (2) left and right reference lines) may be used as DC prediction.

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices including the constraint server and the rendezvous point/server containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed”.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method for video encoding or video decoding, the method comprising:
selecting a spatial neighboring block that has motion information for prediction;
determining motion information for a current block based on the motion information of the selected spatial neighboring block;
obtaining a set of reference samples adjacent to the current block by applying the motion information for the current block; and
performing intra prediction of the current block using at least a line of reference samples from the set of generated reference samples.

2. The method of claim 1, wherein the line of reference samples is adjacent to the current block and arranged along an edge of the current block.

3. The method of claim 1, wherein the line of reference samples is arranged along any of: the right edge of the current block, the bottom edge of the current block, the left edge of the current block, and the top edge of the current block.

4. The method of claim 1, wherein the spatial neighboring block is any of: (1) not yet reconstructed at a time at which the current block is predicted, or (2) reconstructed after the current block according to a known block reconstruction order.

5. The method of claim 1, wherein performing intra prediction of the current block further comprises using another line of reference samples,
wherein the reference samples of the other line are selected from any number of already reconstructed blocks adjacent to the current block.

6. The method of claim 1, wherein performing intra prediction of the current block further comprises using another line of reference samples,
wherein the reference samples of the other line are generated using motion information of another spatial neighboring block adjacent to the current block, and
wherein the other spatial neighboring block is a different block than the spatial neighboring block.

7. The method of claim 1, wherein performing intra prediction of the current block further comprises using the line of reference samples to generate prediction samples for the current block according to any of: a planar intra prediction mode, a DC intra prediction mode, and a directional intra prediction mode.

8. The method of claim 1, wherein performing intra prediction of the current block generates an intra prediction of the current block that is combined with another prediction signal according to an inter and intra combined merge mode.

9. The method of claim 1, wherein the intra prediction of the current block is performed at any of: (1) a video encoder, wherein the current block is part of a picture being encoded, and (2) a video decoder, wherein the current block is part of a picture being decoded.

10. A device for video encoding or video decoding, comprising circuitry including a transmitter, a receiver, an encoder, a decoder, a processor and a memory, configured to:
select a spatial neighboring block that has motion information for prediction;
determine motion information for a current block based on the motion information of the selected spatial neighboring block;
obtain a set of reference samples adjacent the current block by applying the motion information for the current block; and
perform intra prediction of the current block using at least a line of reference samples from the set of generated reference samples.

11. The device of claim 10, wherein the line of reference samples is adjacent to the current block and arranged along an edge of the current block.

12. The device of claim 10, wherein the line of reference samples is arranged along any of: the right edge of the current block, the bottom edge of the current block, the left edge of the current block, and the top edge of the current block.

13. The device of claim 10, wherein the spatial neighboring block is any of: (1) not yet reconstructed at a time at which the current block is predicted, or (2) reconstructed after the current block according to a known block reconstruction order.

14. The device of claim 10, wherein performing intra prediction of the current block further comprises using another line of reference samples, and
wherein the reference samples of the other line are selected from among any number of already reconstructed blocks adjacent to the current block.

15. The device of claim 10, wherein performing intra prediction of the current block further comprises using another line of reference samples,
wherein the reference samples of the other line are generated using motion information of another spatial neighboring block adjacent to the current block, and
wherein the other spatial neighboring block is a different block than the spatial neighboring block.

16. The device of claim 10, wherein the line of reference samples is any of a top reference line, a bottom reference line, a left reference line, or a right reference line.

17. The device of claim 10, wherein the line of reference samples is determined according to any of a candidate pixel and motion information associated with the candidate pixel.

18. The device of claim 17, wherein the candidate pixel is from among one or more unreconstructed neighboring blocks.

19. The device of claim 10, wherein the corresponding block is any of a CU and a sub-CU, and
wherein each of the CU and the sub-CU have respective heights and widths of numbers of pixels.

20. The device of claim 19, wherein the CU is an intra CU and the sub-CU is an intra sub-CU, and
wherein any of the intra CU and the intra sub-CU is for an inter picture.
